(19) United States
(12) Patent Application Publication
(10) Pub. No.: US 2022/0103028 A1
(43) Pub. Date: Mar. 31, 2022

(54) MOTOR ROTOR PLATE, MOTOR ROTOR HAVING MOTOR ROTOR PLATE, AND MOTOR HAVING MOTOR ROTOR

(71) Applicant: CHAMP TECH OPTICAL (FOSHAN) CORPORATION, Foshan (CN)

(72) Inventors: YOU-ZHI LU, Foshan (CN); YONG-KANG ZHANG, Foshan (CN); YUNG-PING LIN, New Taipei (TW)

(21) Appl. No.: 17/160,142

(22) Filed: Jan. 27, 2021

(30) Foreign Application Priority Data
Sep. 25, 2020 (CN) 202011025085.0

(51) Int. Cl. H02K 1/26; H02K 9/06

(52) U.S. Cl. CPC H02K 1/265; H02K 9/06

(57) ABSTRACT

A motor rotor plate includes a rotating shaft, a connecting portion coupled to the rotating shaft to drive the rotating shaft to rotate, and a plurality of electrode portions used to wind a coil. The electrode portions are spaced around the connecting portion at a same interval. One end of each electrode portion is coupled to the connecting portion. Another end of each electrode portion extends outward in a radial direction of the connecting portion. A width of each electrode portion gradually increases along the radial direction of the connecting portion to increase an area of the electrode portion, thereby increasing a magnetic flux, so that an electric current of the coil is reduced while maintaining a certain rotation speed to reduce heat generation.

### FIELD

The subject matter herein generally relates to motor rotors, and more particularly to a motor rotor plate of the motor rotor.

### BACKGROUND

Referring to FIG. 4, a shape of a motor rotor plate in the related art has the problem that a magnetic flux is not high enough. As a result, when a certain speed is maintained, a coil on the motor rotor plate requires a large electric current, which in turn leads to the conversion of electrical energy into magnetic energy, which results in a large amount of heat generation.

### BRIEF DESCRIPTION OF THE DRAWINGS

Implementations of the present disclosure will now be described, by way of embodiments, with reference to the attached figures.

FIG. 1 is a schematic diagram of a motor rotor plate, a rotating shaft, and a coil of a motor according to an embodiment of the present disclosure.

FIG. 2 is a schematic diagram of the motor rotor plate in FIG. 1.

FIG. 3 is a schematic diagram of the motor rotor plate in FIG. 2 showing size dimensions of the motor rotor plate.

FIG. 4 is a schematic diagram of a motor rotor plate in the related art.

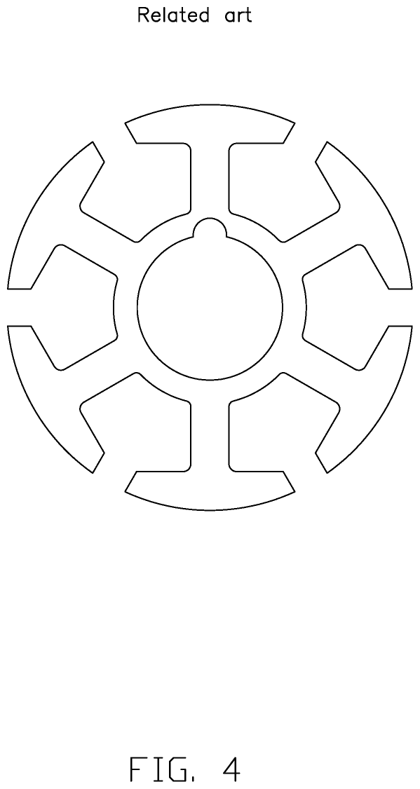

FIG. 5 is a schematic diagram of a motor rotor according to an embodiment of the present disclosure.

FIG. 6 is an exploded view of a motor according to an embodiment of the present disclosure.

FIG. 7 is a schematic diagram of a fan according to an embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

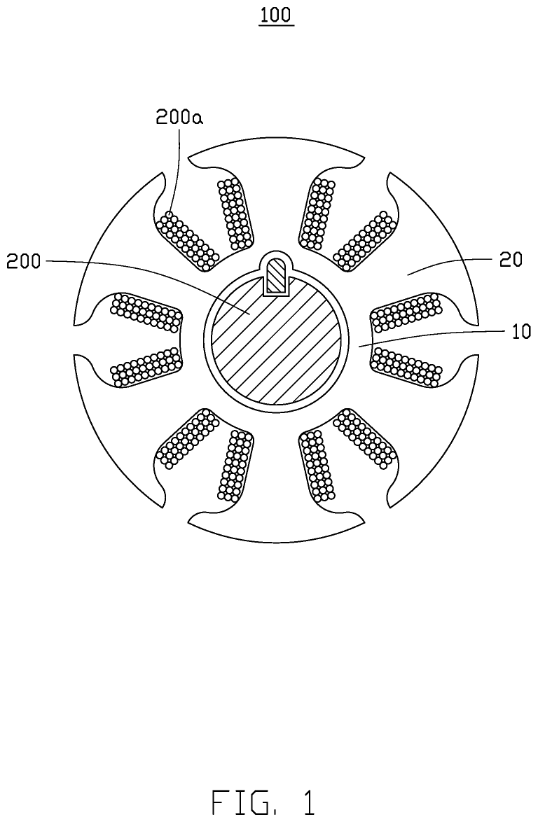

FIG. 1 shows an embodiment of a motor rotor plate 100 for driving a rotating shaft 200 of a motor to rotate. The motor rotor plate 100 includes a connecting portion 10 and a plurality of electrode portions 20. The connecting portion 10 is coupled to the rotating shaft 200 and drives the rotating shaft 200 to rotate. The electrode portions 20 are used to wind a coil 200a. The electrode portions 20 are spaced around the connecting portion 10 at a same interval. One end of each electrode portion 20 is coupled to the connecting portion 10, and another end of each electrode portion 20 extends outward along a radial direction of the connecting portion 10. The electrode portions 20 are in a same plane as the connecting portion 10. A width of the electrode portion 20 gradually increases along a radial direction of the connecting portion 10 to increase an area of the electrode portion 20, thereby increasing a magnetic flux of the electrode portion 20, so that an electric current of the coil 200a is reduced while the motor rotor plate 100 maintains a certain rotation speed, thereby reducing heating of the motor rotor plate 100 and reducing a magnetic flux loss.

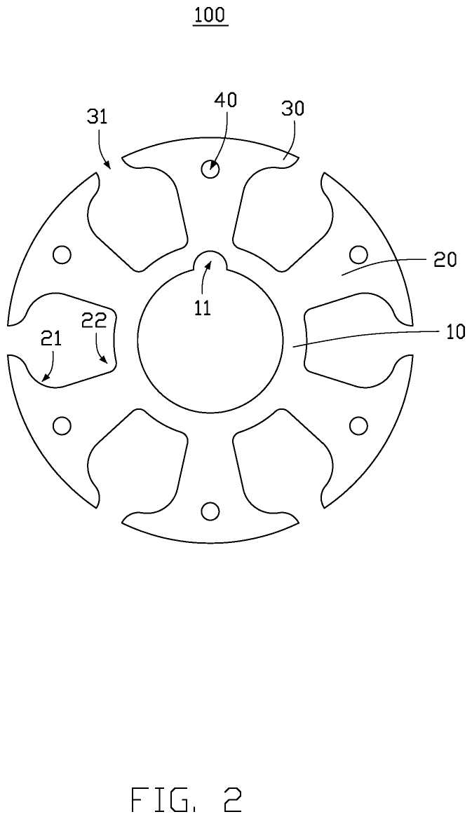

Referring to FIG. 2, an end of each electrode portion 20 away from the connecting portion 10 is provided with a stopping portion 30. The stopping portion 30 is used to prevent the coil 200a from separating from the electrode portions 20 due to a centrifugal force during rotation. The stopping portion 30 is located in a rotation plane of the electrode portions 20. A first rounded corner 21 is provided at a connection joint between the electrode portion 20 and the stopping portion 30. The first rounded corner 21 is used to guide a magnetic field to be distributed smoothly and avoid sudden changes in the magnetic field.

In one embodiment, the electrode portions 20 are symmetrically arranged along the radial direction of the connecting portion 10, and a size of each electrode portion 20 is the same, so that a number of coil windings on each electrode portion 20 is the same, and the magnetic field is uniformly distributed.

In one embodiment, the stopping portion 30 is symmetrically arranged on two sides of each electrode portion 20, and a gap 31 is defined between two opposing stopping portions 30 of every two adjacent electrode portions 20. The gap 31 facilitates the winding of the coil onto the electrode portion 20.

In one embodiment, the stopping portions 30 and an outer side of the electrode portions 20 form an arc concentric with the connecting portion 10 to maximize the area of the electrode portions 20 and thereby increase the magnetic flux.

In one embodiment, a plurality of the motor rotor plates 100 is arranged in a stack to increase a torque of the motor rotor plates 100. In order to fix the plurality of motor rotor plates 100 together, a riveting hole 40 is provided at an end portion of each electrode portion 20 away from the connecting portion 10. The riveting hole 40 is convenient for riveting the stacked motor rotor plates together 100. A center of the riveting hole 40 is located on a center line of the electrode portion 20 to guide stable distribution of the magnetic field and avoid sudden changes in the magnetic field.

In one embodiment, a second rounded corner 22 is provided at a connection joint between the electrode portion 20 and the connecting portion 10. The second rounded corner 22 is used to guide the magnetic field to distribute smoothly and avoid sudden changes in the magnetic field.

Referring to FIGS. 1 and 2, the connecting portion 10 has a substantially circular ring shape, and a groove 11 is defined on an inner side of the connecting portion 10.

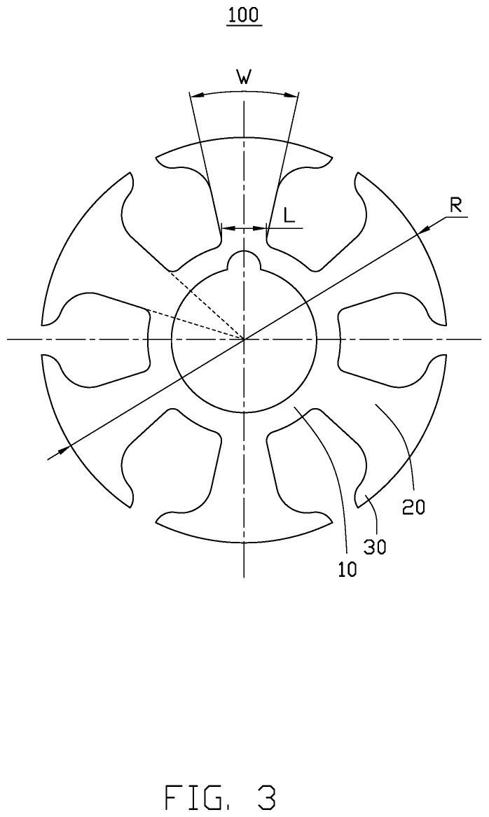

Referring to FIG. 3, the connecting portion 10 is coupled to six electrode portions 20. A diameter R of the arc formed by the stopping portions 30 and the electrode portions 20 is 16.75-16.8 mm, such as 16.75 mm, 16.76 mm, 16.78 mm, 16.79 mm, or 16.8 mm. A width L of the connection joint between each electrode portion 20 and the connecting portion 10 is 1.95-2 mm, such as 1.95 mm, 1.97 mm, 1.98 mm, or 2 mm. Two side edges of each electrode portion 20 are arranged along a radial direction of the connecting portion 10, that is, extension lines of the two side edges of the electrode portion 20 converge at a center of the connecting portion 10. An included angle W formed between the two side edges of the electrode portion 20 is 23.8 degrees.

Specifically, in one embodiment, the motor rotor plate 100 is a silicon steel sheet. Compared with other materials, silicon steel has higher magnetic permeability and greater resistivity and can better reduce magnetic consumption. In other embodiments, the motor rotor plate 100 may be made of a conductive material such as iron.

Specifically, in one embodiment, a thickness of the motor rotor plate 100 is 0.35 mm, and two motor rotor plates 100 riveted together have a thickness of 0.7 mm. After coating a layer of 0.06 mm insulating film on opposite surfaces of the two riveted motor rotor plates 100, the total thickness is only 0.82 mm.

In other embodiments, the connecting portion 10 can be coupled to other numbers of electrode portions 20, such as twelve. The motor rotor plate 100 can have other sizes, and the included angle formed between the two side edges of each electrode portion 20 can be other degrees, such as 24 degrees.

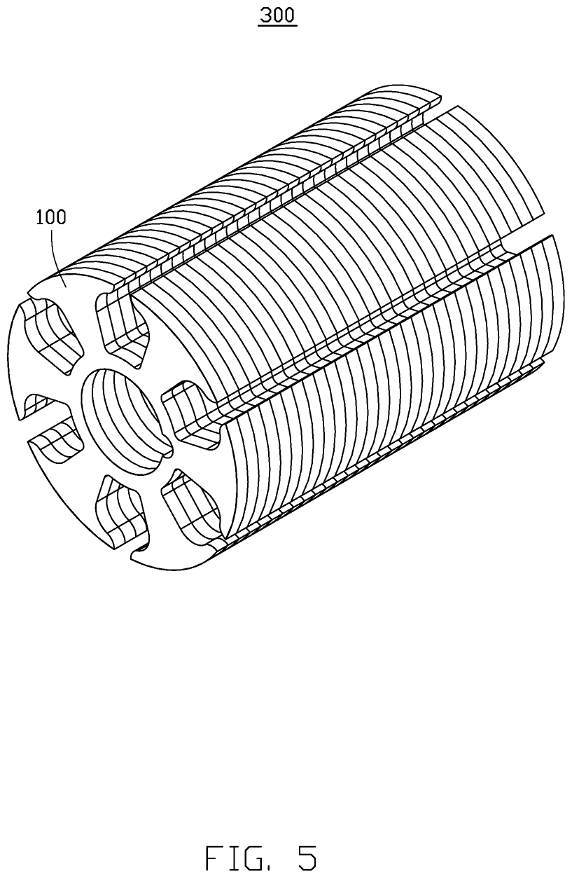

FIG. 5 shows an embodiment of a motor rotor 300, which includes a plurality of motor rotor plates 100 stacked together. The plurality of motor rotor plates 100 is riveted together through corresponding riveting holes 40 (shown in FIG. 2). The motor rotor 300 achieves the purpose of reducing the electric current of the coil 200a while maintaining the same rotation speed, thereby reducing heat generation.

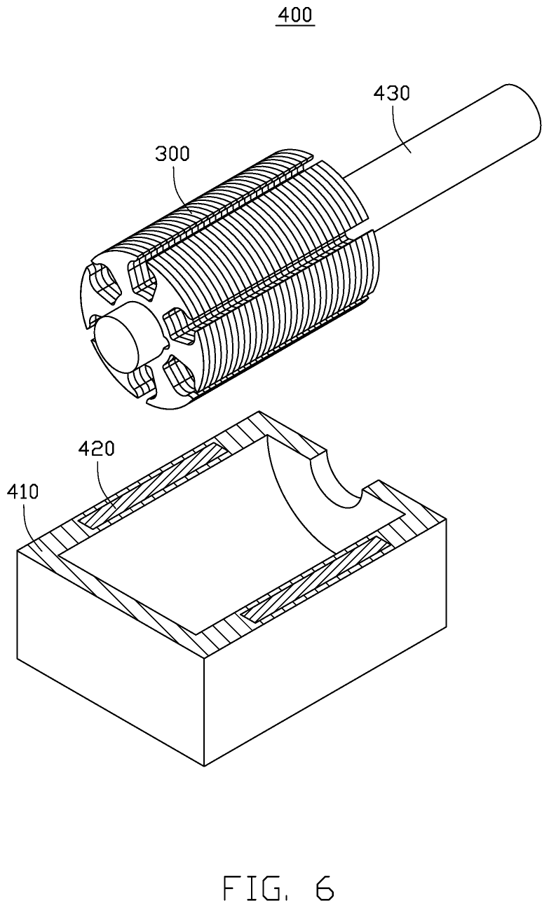

FIG. 6 shows an embodiment of a motor 400 including a housing 410, a motor stator 420, the motor rotor 300, and a rotating shaft 430. The motor stator 420 is fixed in the housing 410. In one embodiment, the motor stator 420 is a permanent magnet. The motor rotor 300 is fixedly coupled to the rotating shaft 430. The rotating shaft 430 may be the same as the rotating shaft 200 in FIG. 1. The rotating shaft 430 is rotationally coupled to the housing 410. A magnetic field generated after the motor rotor 300 is energized interacts with a magnetic field of the motor stator 420 so that the motor rotor 300 drives the rotating shaft 430 to rotate. The motor 400 with the motor rotor plates 100 achieves the purpose of reducing the electric current of the coil 200a while maintaining the same rotation speed, thereby reducing heat generation.

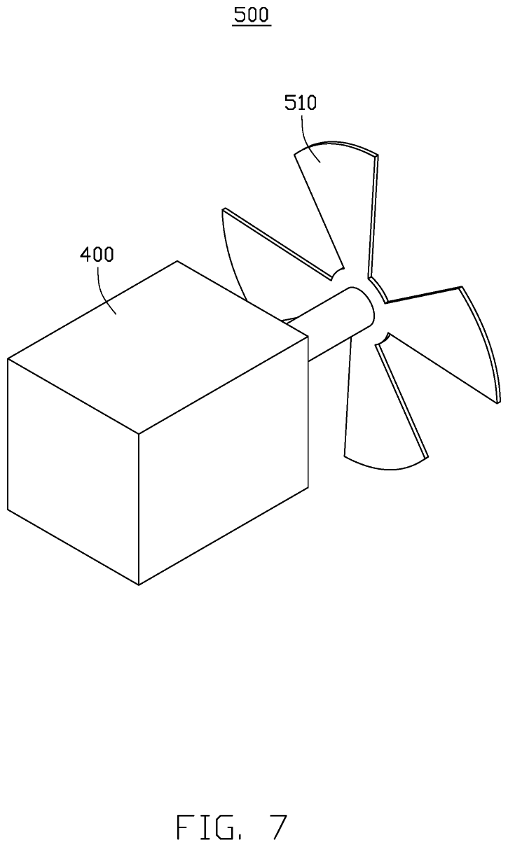

FIG. 7 shows an embodiment of a fan 500 including fan blades 510 and the motor 400. The fan blades 510 are coupled to the rotating shaft 430 of the motor 400. The motor 400 drives the fan blades 510 to rotate to dissipate heat. The fan 500 using the motor 400 with the motor rotor plates 100 achieves the purpose of reducing the electric current of the coil 200a while maintaining the same rotation speed, thereby reducing heat generation.

In summary, each electrode portion 20 of the motor rotor plate 100 gradually increase in width along the radial direction of the connecting portion 10, thereby increasing the area of the electrode portion 20 and increasing the magnetic flux. Thus, the electric current of the coil 200a can be reduced, thereby reducing heat generation. The above-mentioned motor rotor 300 achieves the purpose of reducing the electric current of the coil 200a while maintaining the same rotation speed through the above-mentioned motor rotor plates 100, thereby reducing heat generation. The motor 400 achieves the purpose of reducing the electric current of the coil 200a while maintaining the same rotation speed through the motor rotor 300, thereby reducing heat generation. The fan 500 uses the motor 400 to achieve the purpose of reducing the electric current of the coil 200a while maintaining the same rotation speed, thereby reducing heat generation.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A motor rotor plate comprising:
a rotating shaft;
a connecting portion coupled to the rotating shaft to drive the rotating shaft to rotate; and
a plurality of electrode portions used to wind a coil, the plurality of electrode portions spaced around the connecting portion at a same interval, one end of each electrode portion coupled to the connecting portion, and another end of each electrode portion extending outward in a radial direction of the connecting portion, wherein a width of each electrode portion gradually increases along the radial direction of the connecting portion to increase an area of the electrode portion, thereby increasing a magnetic flux, so that an electric current of the coil is reduced while maintaining a certain rotation speed to reduce heat generation.

2. The motor rotor plate of claim 1, wherein:
the end of each electrode portion away from the connecting portion is provided with a stopping portion; and
the stopping portion is used to prevent the coil from separating from the electrode portion.

3. The motor rotor plate of claim 2, wherein:
the plurality of electrode portions is symmetrically arranged along the radial direction of the connecting portion;
the stopping portion is symmetrically arranged on two sides of each electrode portion; and
a gap is defined between two opposing stopping portions of each two adjacent electrode portions.

4. The motor rotor plate of claim 3, wherein:
the stopping portions and the plurality of electrode portions jointly form an arc concentric with the connecting portion.

5. The motor rotor plate of claim 4, wherein:
an end portion of each electrode portion away from the connecting portion is provided with a riveting hole; and
a center of the riveting hole is located on a center line of the electrode portion.

6. The motor rotor plate of claim 2, wherein:
a first rounded corner is provided at a connection joint between the electrode portion and the stopping portion; and
a second rounded corner is provided at a connection joint between the electrode portion and the connecting portion.

7. The motor rotor plate of claim 4, wherein:
a diameter of the arc is 16.75-16.8 mm;
a width of each electrode portion is 1.95-2 mm;
two side edges of each electrode portion are arranged along the radial direction of the connecting portion; and
the included angle formed between the two side edges is 23.8 degrees.

8. A motor rotor comprising a plurality of motor rotor plates stacked together, each of the plurality of motor rotor plates comprising:
a rotating shaft;
a connecting portion coupled to the rotating shaft to drive the rotating shaft to rotate; and
a plurality of electrode portions used to wind a coil, the plurality of electrode portions spaced around the connecting portion at a same interval, one end of each electrode portion coupled to the connecting portion, and another end of each electrode portion extending outward in a radial direction of the connecting portion, wherein a width of each electrode portion gradually increases along the radial direction of the connecting portion to increase an area of the electrode portion, thereby increasing a magnetic flux, so that an electric current of the coil is reduced while maintaining a certain rotation speed to reduce heat generation.

9. The motor rotor of claim 8, wherein:
the end of each electrode portion away from the connecting portion is provided with a stopping portion; and
the stopping portion is used to prevent the coil from separating from the electrode portion.

10. The motor rotor of claim 9, wherein:
the plurality of electrode portions is symmetrically arranged along the radial direction of the connecting portion;
the stopping portion is symmetrically arranged on two sides of each electrode portion; and
a gap is defined between two opposing stopping portions of each two adjacent electrode portions.

11. The motor rotor of claim 10, wherein:
the stopping portions and the plurality of electrode portions jointly form an arc concentric with the connecting portion.

12. The motor rotor of claim 11, wherein:
an end portion of each electrode portion away from the connecting portion is provided with a riveting hole; and
a center of the riveting hole is located on a center line of the electrode portion.

13. The motor rotor of claim 12, wherein:
a first rounded corner is provided at a connection joint between the electrode portion and the stopping portion; and
a second rounded corner is provided at a connection joint between the electrode portion and the connecting portion.

14. The motor rotor of claim 13, wherein:
a diameter of the arc is 16.75-16.8 mm;
a width of each electrode portion is 1.95-2 mm;
two side edges of each electrode portion are arranged along the radial direction of the connecting portion; and
the included angle formed between the two side edges is 23.8 degrees.

15. A motor comprising:
a housing;
a motor stator fixed in the housing;
a motor rotor; and
a rotating shaft fixed on the motor rotor and rotationally coupled to the housing, the motor rotor comprising a plurality of motor rotor plates stacked together, each of the plurality of motor rotor plates comprising:
a rotating shaft;
a connecting portion coupled to the rotating shaft to drive the rotating shaft to rotate; and
a plurality of electrode portions used to wind a coil, the plurality of electrode portions spaced around the connecting portion at a same interval, one end of each electrode portion coupled to the connecting portion, and another end of each electrode portion extending outward in a radial direction of the connecting portion, wherein a width of each electrode portion gradually increases along the radial direction of the connecting portion to increase an area of the electrode portion, thereby increasing a magnetic flux, so that an electric current of the coil is reduced while maintaining a certain rotation speed to reduce heat generation.

16. The motor rotor of claim 15, wherein:
the end of each electrode portion away from the connecting portion is provided with a stopping portion; and
the stopping portion is used to prevent the coil from separating from the electrode portion.

17. The motor rotor of claim 16, wherein:
the plurality of electrode portions is symmetrically arranged along the radial direction of the connecting portion;
the stopping portion is symmetrically arranged on two sides of each electrode portion; and
a gap is defined between two opposing stopping portions of each two adjacent electrode portions.

18. The motor rotor of claim 17, wherein:
the stopping portions and the plurality of electrode portions jointly form an arc concentric with the connecting portion.

19. The motor rotor of claim 18, wherein:
an end portion of each electrode portion away from the connecting portion is provided with a riveting hole; and
a center of the riveting hole is located on a center line of the electrode portion.

20. The motor rotor of claim 19, wherein:
a first rounded corner is provided at a connection joint between the electrode portion and the stopping portion;
a second rounded corner is provided at a connection joint between the electrode portion and the connecting portion;
a diameter of the arc is 16.75-16.8 mm;
a width of each electrode portion is 1.95-2 mm;
two side edges of each electrode portion are arranged along the radial direction of the connecting portion; and
the included angle formed between the two side edges is 23.8 degrees.
